(19) United States
(12) Patent Application Publication
(10) Pub. No.: US 2015/0264909 A1
(43) Pub. Date: Sep. 24, 2015

(54) Modular, Configurable Bait Board System

(71) Applicant: Lee Brummel, Gresham, OR (US)

(72) Inventor: Lee Brummel, Gresham, OR (US)

(21) Appl. No.: 14/604,360

(22) Filed: Jan. 23, 2015

Related U.S. Application Data
(60) Provisional application No. 61/931,452, filed on Jan. 24, 2014.

(51) Int. Cl. A01K 97/04; A47B 13/16; A01K 99/00

(52) U.S. Cl. CPC A01K 97/04; A01K 99/00; A47B 13/16

(57) ABSTRACT

A bait board with modular attachments is disclosed. The bait board has a sidewall and additional secondary walls that define compartments. The sidewall and secondary walls have essentially the same thickness and height, such that a number of attachments with depending flanges can fit over the walls and in the compartments to removably attach to the bait board.

### CROSS-REFERENCE TO RELATED APPLICATIONS

This application claims priority to, and the benefit of, U.S. Provisional Patent Application No. 61/931,452, filed Jan. 24, 2014. That application is incorporated by reference in its entirety.

### BACKGROUND OF THE INVENTION

1. Field of the Invention

The invention relates to bait boards.

2. Description of Related Art

Bait boards are multipurpose work surfaces that are used in fishing, for example, to prepare bait and lures. The typical bait board is fixedly mounted on a fishing boat in a convenient location so that it can be used while fishing. While several different mounts are available, one common mount that may be used is a pole mounted on the transom of the boat. Other, more complex, mounts may allow the bait board to be tilted in use.

The board itself is generally made of a material that is impermeable to blood and fluids and is easy to wash clean, such as a plastic. Some boards include built-in, fixed accessory racks for holding gear and lures, and some boards include or are associated with other structures, like holders for fishing rods.

Although there are many different models of bait board on the market, and many of those do offer helpful features, conventional bait boards are fixed in their configurations, and do not provide the user with much choice or adaptability in how to arrange his or her tools and gear while working.

### SUMMARY OF THE INVENTION

One aspect of the invention relates to a modular, configurable bait board system. The bait board system comprises a bait board and work surface with a number of part attachment points. The system also includes a number of parts that are adapted to attach to the attachment points. The parts may include can holders, scent boards, knife holders, and leader dispensers, to name a few. In some embodiments, the attachment points may comprise compartments that are designed to receive engaging portions of the parts. The engagement between the compartments and the parts may be by means of a tight, frictional fit or by using fasteners. The compartments may be sized such that even if one of the parts is mounted in a compartment, at least a portion of the compartment can also be used for storage. The bait board and parts may be made of a material that is easily cleaned and is generally impervious to blood and fluids. In some embodiments, the material may be a food-grade plastic. In some embodiments, the bait board and parts may be attachable in a storage configuration that minimizes the profile or space consumed by the system.

These and other aspects, features, and advantages of the invention will be set forth in the description that follows.

### BRIEF DESCRIPTION OF THE DRAWING FIGURES

The invention will be described with respect to the following drawing figures, in which like numerals represent like features, and in which:

FIG. 1 is a perspective view of a bait board system according to one embodiment of the invention in use, carrying tools and supplies;

FIG. 2 is a perspective view of the bait board system of FIG. 1 in a different configuration and without tools or supplies;

FIG. 3 is a perspective view of the bait board in isolation, without parts installed, illustrating some of the parts laid out for possible attachment;

FIG. 4 is a perspective view of the base board and some of the parts of FIG. 3;

FIG. 5 illustrates yet another alternate configuration of the bait board system of FIG. 1;

FIG. 6 illustrates yet another alternate configuration of the bait board system of FIG. 1; and

FIG. 7 illustrates a storage configuration of the bait board system of FIG. 1, with the parts attached in a non-operational condition.

### DETAILED DESCRIPTION

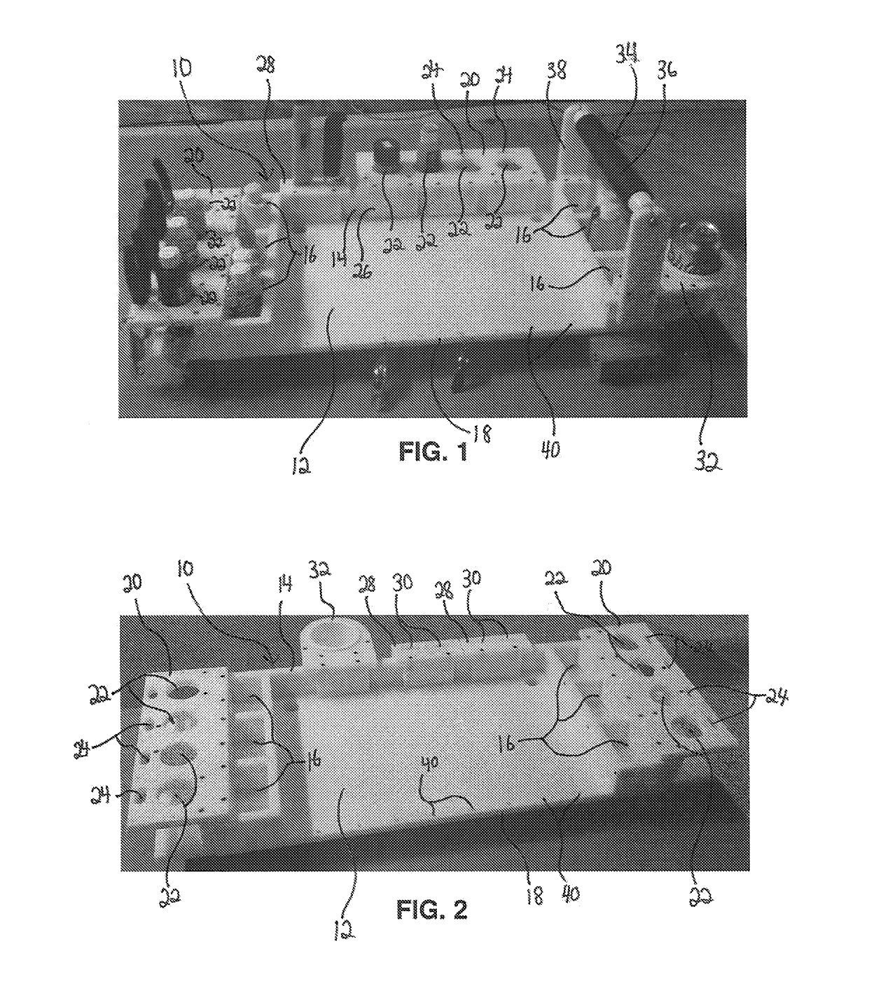

FIG. 1 is a perspective view of a modular, reconfigurable bait board system, generally indicated at 10, according to one embodiment of the invention. The bait board system 10 includes a bait board 12 and a number of parts that are configured to be attachable to the bait board 12 at the user's discretion and in a way determined by the user. Thus, in operation, the bait board 12 may have a number of different parts attached, and may have any number of configurations while in use.

To facilitate the modularity and configurability of the bait board system 10, the bait board 12 has a number of attachment points. In the illustrated embodiments, these attachment points comprise the rear, raised wall 14 of the bait board 12 and the sidewalls and interior volumes of a number of compartments 16 that are provided along the sides of the bait board 12. In the illustrated embodiment, the bait board 12 has six compartments 16, three compartments 16 on each side of the bait board 12, although more or fewer compartments 16 may be present in other embodiments. These compartments 16 span the entire depth of the bait board, terminating in the rear contiguous with the rear wall 14 and in the front with the front edge 18 of the bait board 12. Of course, the dimensions and proportions of the compartments 16 may be different in different embodiments.

Thus, in the illustrated embodiment, the compartments 16 and rear wall 14 serve as attachment points. For that reason, the compartments 16 have uniform wall thickness and dimensions, such that parts may be interchangeably placed in any of the compartments 16. The wall heights may differ from embodiment to embodiment, but a wall height of about 1.75 inches has been found to be suitable in at least some embodiments. As will be described below in more detail, the parts fit over the walls of the bait board 12 and compartments 16, as well as in the compartments 16 themselves. Once placed, the parts remain on the bait board 12 because of tight and precisely-dimensioned fits between the parts and the compartments 16, rear wall 14, and various sidewalls. However, in other embodiments, other forms of securement may be used, including thumb screws, clips, and other conventional forms of attachment hardware.

In the view of FIG. 1, the bait board 12 is configured with a first scent board 20. The first scent board 20 is attached to one side of the bait board 12 and includes four round compartments 22 sized to hold bottles of scent and a set of four slots sized to hold pliers and other tools. A second, identical scent board 20 is attached along the rear wall 14 of the bait board 12. A depending set of flanges 26 allows the scent boards 20 to attach along the edges of the bait board 12. The set of flanges 26 is discontinuous, allowing the individual flanges 26 to fit in the compartments 16 or to fit over the rear wall 14.

Another part shown in FIG. 1 is a knife sheath 28, which is fitted over the rear wall 14 in the view of FIG. 1. The knife sheath 28 has two slits 30 in its top surface, each sized to accommodate a knife blade, such as a fillet knife blade. However, the sheath 28 does not have fully internal structure for housing a knife blade. Instead, the sheath essentially comprises the top surface that defines the slit 30 and a depending flange (not shown in FIG. 1) that allows it to attach to the wall 14. When a knife blade is inserted into the slit 30, the knife blade is wedged between the outer sidewall of the bait board 12 and the depending flange of the knife sheath 28.

Two other parts are shown in FIG. 1: a can holder 32, and a leader dispenser 34. The leader dispenser 34 comprises a rod 36, which may be covered with rubber non-slip material, that is mounted for rotation on two h-shaped brackets 38 that fit over and are secured to the walls of the compartments 16 such that the leader dispenser 34 extends substantially the entire depth of the bait board 12. Other leader dispensers may be different in length and other features, as will be described below in more detail.

FIG. 2 is a perspective view of the bait board system 10 in an alternate configuration and without gear or tools installed. In the view of FIG. 2, two scent boards 20, two knife sheathes 28, and a can holder 32 are installed on the bait board 12. The two scent boards 20 are installed symmetrically on both sides of the board 12, while the knife sheathes 28 and can holder 32 are installed along the rear wall 14.

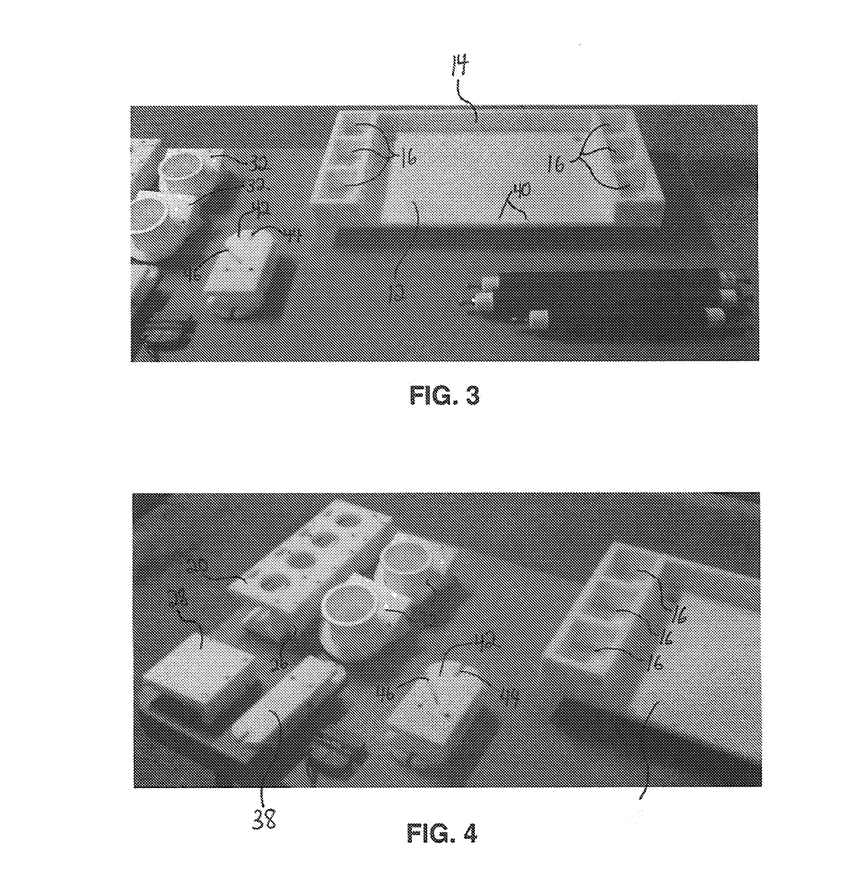

FIG. 3 is a perspective view of the bait board 12 in isolation, illustrating the compartments 16 and other features. As shown, between the sets of compartments 16, the surface of the bait board 12 is generally flat in order to provide a work surface. In addition to the compartments 16 and the work surface that it provides, the bait board 12 may include any number of other built-in features. For example, as can be seen in FIGS. 1-3, the forward edge 18 of the bait board 12 includes a number of openings 40 that can be used to hang lures.

FIG. 3 and the perspective view of FIG. 4 also illustrate a number of parts in isolation, including a scent board 20, a knife sheath 28, one of the h-shaped brackets 38, and two can holders 32. FIG. 4 also shows an alternative bracket 42 for a leader dispenser. The bracket 42 has a first vertical slot 44 at the top to accept one rod, and a second angled slot 46 extending inward from an edge. Thus, with the bracket 42, a leader dispenser with two rotating rods may be installed on the bait board 20. As shown, each of the parts 20, 28, 32, 38, 42 has a depending flange, like the flange 26 of the scent board 20.

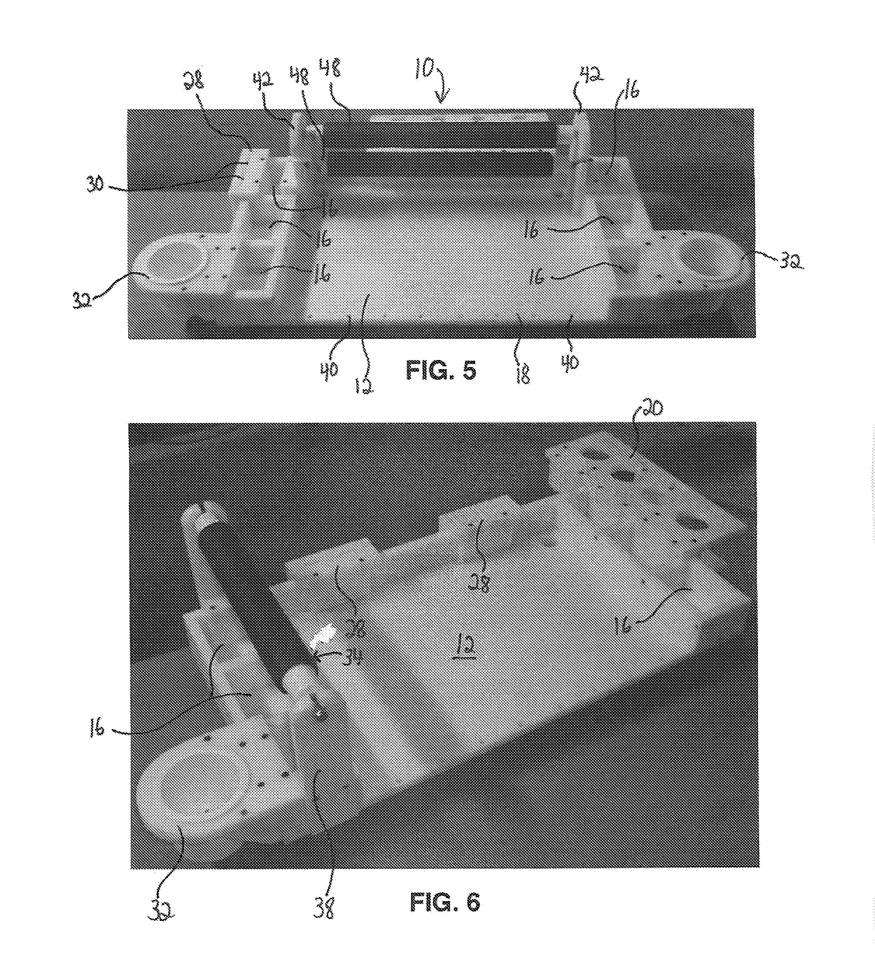

FIGS. 5 and 6 are perspective views illustrating the bait board system 10 in different configurations. In the view of FIG. 5, two can holders 32 are installed symmetrically, outboard, on either side of the bait board 12. Additionally, a leader dispenser with two rotating rods 48 supported by a pair of brackets 42 spans the work surface of the bait board 12 and is attached to the rearward-most compartment 16 on each side. A knife sheath 28 is installed outboard in the rearward-most compartment 16.

In FIG. 6, two knife sheathes 28 are installed along the rear wall 14, a scent board 20 is installed on one side in two compartments 16 so that a portion of it extends behind the bait board 12. A can holder 32 and leader dispenser 34 are installed on the other side. The positioning of the scent board 20 in FIG. 6 illustrates a particular point of installing and arranging parts in the system 10: the parts need not coincide perfectly with the board 12 and may extend beyond it in various directions in at least some embodiments. Additionally, the configurations shown in at least FIGS. 5-6 illustrate another point: in some cases, a compartment 16 may simultaneously serve as an attachment point for more than one part. In FIG. 5, one compartment 16 serves as an attachment point for the leader dispenser bracket 42 and for the knife sheath 28. In FIG. 6, one compartment 16 serves as an attachment point for a bracket 38 and a can holder 32.

As can be appreciated from FIGS. 1-6, the bait board system 10 may be arranged in virtually any configuration that a user desires, using any parts that a user desires. In some embodiments, the bait board 12 may be sold in a kit with a defined set of parts. In other embodiments, the bait board 12 may be sold alone and the parts sold separately. In either case, additional parts may be sold separately.

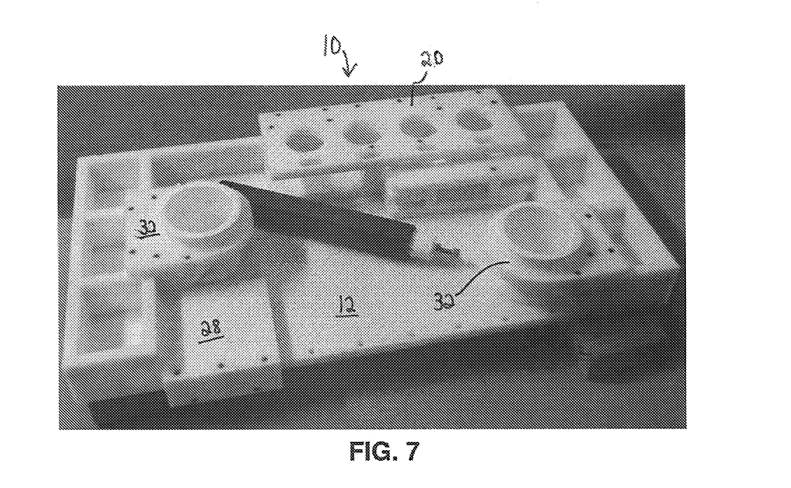

In addition to operational configurations, the bait board system 10 may have non-operational configurations that can be used to store the components together. FIG. 7 is a perspective view of the bait board system 10 in a non-operational storage configuration. In FIG. 7, two can holders 32, a scent board 20, a knife sheath 28 and the components of a leader dispenser 34 are present, but these components are arranged to fit within the area of the bait board 12. That is, where certain components, like the can holders 32, would normally be positioned outboard of the bait board 12, they are instead positioned to extend inwardly.

Bait boards 12 themselves may be made to various dimensions, although it is advantageous if the compartments 16 or other features used as attachment points are made to standardized dimensions, so that parts will fit interchangeably on bait boards of different dimensions. As one example, a bait board may be made about 12 inches in depth and about 22, 24, 26, or 28 inches in length. While any dimensions may be used, it may be useful to keep one dimension the same so as to facilitate installation in a variety of boats and other settings.

The bait board system 10 is preferably made of a material that is easily cleaned and is resistant to weather and corrosion, although different parts may be made of different materials. In the illustrated embodiments, the bait board 12 and its parts are made of a food-grade high density polyethylene (HDPE). When made of a plastic, the parts of the bait board system 10 may be either molded or machined and assembled. In the illustrated embodiment, the components of the bait board system 10 are machined and assembled from sheet stock material with marine-grade stainless steel hardware, such as 316SS screws, used to reduce the possibility of corrosion.

The bait board system 10 may use any kind of mounting system to secure it to an appropriate location. In some cases, different versions of the bait board 12 may be made with different mounting hardware. In other cases, appropriate mounting hardware may simply be made attachable to the board.

While the invention has been described with respect to certain embodiments, the embodiments are intended to be illuminating, rather than limiting. Modifications and changes may be made within the scope of the invention, which is defined by the appended claims.

What is claimed is:

1. A bait board, comprising:
a generally flat work surface adapted to connect directly or indirectly to a portion of a boat;
a generally vertical sidewall arising around at least three sides of the work surface;
one or more secondary walls attached to the work surface and defining one or more compartments, the one or more secondary walls having a height essentially equal to a height of the sidewall and a thickness essentially equal to a thickness of the sidewall; and
one or more attachments having one or more depending flanges spaced and configured to fit over the thickness of the sidewall or one or more secondary walls or within one of the compartments so as to removably attach to the bait board.

2. The bait board of claim 1, wherein the attachments are selected from the group consisting of a knife attachment, a leader dispenser bracket, a can holder attachment, and a scent board attachment.

3. The bait board of claim 1, wherein the sidewall and the one or more secondary walls provide a plurality of locations at which to attach the one or more attachments.

4. The bait board of claim 1, wherein the one or more secondary walls are arranged such that there is a column of the one or more compartments on each side of the work surface with a free area in the center of the work surface.

5. The bait board of claim 1, wherein the bait board is made of a plastic.

6. The bait board of claim 5, wherein the plastic comprises high density polyethylene.
